(19) United States
(12) Patent Application Publication
(10) Pub. No.: US 2002/0037162 A1
(43) Pub. Date: Mar. 28, 2002

(54) Recording and playback apparatus, recording and playback method and recording medium

(76) Inventor: Yoshinori Matsumoto, Kanagawa (JP)

Correspondence Address: FROMMER LAWRENCE & HAUG LLP, 745 FIFTH AVENUE, NEW YORK, NY, 10151, US

(21) Appl. No.: 09/957,484

(22) Filed: Sep. 20, 2001

(30) Foreign Application Priority Data
Sep. 22, 2000 (JP) P2000-287956

(51) Int. Cl. H04N 5/76; G11B 7/00

(52) U.S. Cl. 386/126; 369/44.11

(57) ABSTRACT

At a step S4 of a flowchart representing the operation of a disk drive, a recording or playback operation requested by the user is carried out. Then, the flow of the operation goes on to a step S5 to form a judgment as to whether or not to correct focus precision. If the focus precision is to be corrected, the flow of the operations goes on to a step S6 at which a command is issued to move an optical pickup from the current position to a location preceding the current position by 1 track. At the next step S7, the focus precision is corrected by playing back data already recorded on the location preceding the current position by 1 track.

### BACKGROUND OF THE INVENTION

In general, the present invention relates to a recording and playback apparatus, a recording and playback method adopted in the recording and playback apparatus and a recording medium for recording the recording and playback method. More particularly, the present invention relates to a recording and playback apparatus correcting focus precision, a recording and playback method adopted in the recording and playback apparatus and a recording medium for recording the recording and playback method.

Disc-shaped recording media represented by a CD (Compact Disc) used for recording audio signals has been becoming popular. Recording media other than such a CD includes a CD-ROM (Compact Disc-Read Only Memory) used in apparatuses such as a computer for storing programs and a DVD-Video (Digital Versatile-Disk Video) recording medium for recording moving pictures at a high picture quality.

In addition, on the user side, disc-shaped recording media that can be used for recording and playing back information has been also becoming popular. Examples of such disc-shaped recording media are an MD (Mini-Disk) for recording and playing back information by adoption of a magneto-optical technique, an MO (Magnet Optical Disk), a PD (phase change optical disk) for recording and playing back information by adoption of a phase-change recording technique and a DVD-RAM (Digital Versatile Disk-Random Access Memory).

As described above, there is recording media with a variety of disc shapes capable of handling digital data. In addition, digital data recorded on disc-shaped recording media also has a number of recorded-data types such as characters, sounds, still pictures and moving pictures. With the performance of devices such as a microprocessor enhanced in recent years, such digital data can be processed and recorded on to recording media in a real-time manner.

With what is described above serving as a background, it is desirable to also increase the recording capacity of recording media for storing digital data. As a conceivable technique to increase the recording capacity of disc-shaped recording media, the size of the spot of a beam radiated to the recording media during a playback or recording operation is reduced to raise the surface recording density. The size a of a beam spot is given by Eq. (1) as follows:

a=α×λ/NA (1)

where notation a denotes a coefficient determined by distribution of the light intensity, notation λ denotes the wavelength of the beam and notation NA denotes the numerical aperture of an objective lens.

As is obvious from Eq. (1), in order to decrease the size a of the beam spot, it is necessary to reduce the wavelength λ and increase the numerical aperture NA. Thus, by using a semiconductor laser with a small wavelength λ and employing an objective lens having a high numerical aperture NA, a small beam spot can be obtained. As a result, the surface recording density of data recorded on the disc-shaped recording medium can be increased. In addition, it is also possible to construct a recording and playback apparatus capable of recording and playing back data onto and from a recording medium having a large recording capacity.

With the diameter of the beam spot reduced, however, the depth of the focal point also decreases inevitably. Thus, the margin of a defocus, that is, the margin of a focal discrepancy, is also reduced. The depth d of the focal point is proportional to an expression as follows:

d∝λ/(NA)ˆ 2 (2)

As is obvious from the relation of proportion (2) given above, the depth d of the focal point decreases proportionally to a ratio of the wavelength λ to the numerical aperture NA, and the ratio decreases in proportion to the wavelength λ but in inverse proportion to the numerical aperture NA.

Thus, in order to position a recording surface within the depth of the focal point in the implementation of recording and playback operations at a high recording density, it is necessary to execute focusing control with a higher degree of precision.

As described above, by reducing the wavelength λ of the laser beam, increasing the numerical aperture NA of the objective lens and executing the focusing control with a higher degree of precision, the recording capacity of recording media can be increased. A focal discrepancy in focusing control is explained as follows.

Causes generating a focal discrepancy in focusing control include a steady-state deviation due to a residual left at a servo time, a shift in focal-point position due to variations in plate thickness from disc to disc and a variation in offset due to an increase in temperature inside a disk drive setting the disc.

The steady-state deviation due to a residual left at a servo time is determined by the magnitude of a focus external disturbance element and a gain. Thus, in operations to record data onto a recording medium and play back the data from the recording medium at a high recording density, by reducing the number of external disturbances such as vibrations of the disc surface or the magnitude of each external disturbance and by increasing the gain, the steady-state deviation can be reduced.

The shift in focal-point position due to variations in plate thickness from disc to disc can be reduced by adjusting the position of the disc to an optimum point at a time of insertion of the disc into the disk drive so as to improve the precision of the focusing. The position of the disc is adjusted to an optimum point by referring to factors such as the number and the amplitude of jitters of an RF (Radio Frequency) signal played back from a ROM area provided in advance on the disc. The ROM area is an area for recording information such as an ID which varies from disc to disc. In actuality, an optimum point is found by changing the value of a focus bias to a variety of values.

As described above, the steady-state deviation due to a residual left at a servo time and the shift in focal-point position due to variations in plate thickness from disc to disc can be reduced by carrying out processing to decrease a shift of the focal point in the focusing control at a stage prior to an operation to record data onto the disc or to play back data from the disc. However, the variation in offset due to an increase in temperature inside a disk drive setting the disc needs to be reduced while an operation to record data onto the disc or to play back data from the disc is being carried out.

As a method of preventing a focal discrepancy caused by an offset variation in focusing control, typically, a correction area for recording an RF signal is provided in advance on the disc, and the position of an optical pickup making an access to the disc is changed to the correction area in order to carry out a correction in case an increase in temperature in the recording and playback apparatus is detected.

In moving the optical pickup making an access to the disc to the correction area to carry out a correction, however, there is raised a problem that the recording or playback operation must be temporarily suspended. In order to solve this problem in a case wherein data must be processed in a real-time manner, it is necessary to provide the recording and playback apparatus with additional components such as a buffer for temporarily storing data to be processed during the correction. The necessity to provide the recording and playback apparatus with additional components such as a buffer for facilitating a correction raises another problem of a more complex configuration of the recording and playback apparatus.

### SUMMARY OF THE INVENTION

It is an object of the present invention addressing the problems described above to shorten the time it takes to carry out a correction in focusing control by execution of the correction with a predetermined timing by moving an optical pickup to a location, which data has already been recorded at and is closest to a current position of the optical pickup in a recording or playback operation being carried out, and using an RF signal represented the data already recorded at the closest location.

To achieve the above object, according to a first aspect of the present invention, there is provided a recording and playback apparatus, including: judgment means for forming a judgment as to whether or not to correct focus precision in an operation to record data onto an Nth track of a recording medium or play back data from the Nth track; and correction means which is used for correcting the focus precision if the judgment means forms a judgment to correct the focus precision in the operation to record data onto the Nth track of the recording medium or play back data from the Nth track by using a signal representing data existing on an already recorded track closest to the Nth track.

The judgment means is capable of forming a judgment to correct the focus precision if a predetermined period of time is determined to have lapsed.

The judgment means is capable of forming a judgment to correct the focus precision if a temperature inside a disk drive setting the recording medium is determined to have increased by a predetermined temperature raise.

The correction means is capable of correcting the focus precision by using a signal played back from an (N−1)th track immediately preceding the Nth track.

The correction means is capable of correcting the focus precision by determining a focus-bias value fd that provides the absolute value of a difference within a threshold value k where the difference is a difference in amplitude or a difference in jitters value between a signal obtained at a focus bias of (fd+a) and a signal obtained at a focus bias of (fd−a), and notation a denotes a change quantity.

A recording and playback method according to a second aspect of the present invention, there is provided a recording and playback method, including: a judgment step of forming a judgment as to whether or not to correct focus precision in an operation to record data onto an Nth track of a recording medium or play back data from the Nth track; and a correction step which is executed for correcting the focus precision if, at the judgment step, a judgment is formed to correct the focus precision in the operation to record data onto the Nth track of the recording medium or play back data from the Nth track by using a signal representing data existing on an already recorded track closest to the Nth track.

A recording medium according to a third aspect of the present invention, there is provided a program recorded on the recording medium, including: a judgment step of forming a judgment as to whether or not to correct focus precision in an operation to record data onto an Nth track of a recording medium or play back data from the Nth track; and a correction step which is executed for correcting the focus precision if, at the judgment step, a judgment is formed to correct the focus precision in the operation to record data onto the Nth track of the recording medium or play back data from the Nth track by using a signal representing data existing on an already recorded track closest to the Nth track.

In accordance with the recording and playback apparatus described in the first aspect, the recording and playback method described in the second aspect and the recording medium described in the third aspect of the present invention, if a judgment is formed to correct the focus precision in an operation to record data onto an Nth track of a recording medium or play back data from the Nth track, the focus precision is corrected by using a signal representing data existing on an already recorded track closest to the Nth track.

### BRIEF DESCRIPTION OF THE DRAWINGS

FIG. 1 is a diagram showing the configuration of an embodiment implementing a disk drive provided by the present invention;

FIG. 2 is a flowchart representing the operation of the disk drive 1;

FIG. 3 is a flowchart representing details of processing carried out at a step S7 of the flowchart shown in FIG. 2;

FIG. 4 is an explanatory diagram used for describing a performance-function value;

FIGS. 5A and 5B are explanatory diagrams each used for describing the performance-function value; and

FIG. 6 is an explanatory diagram used for describing recording media.

### DETAILED DESCRIPTION OF THE PREFERRED EMBODIMENTS

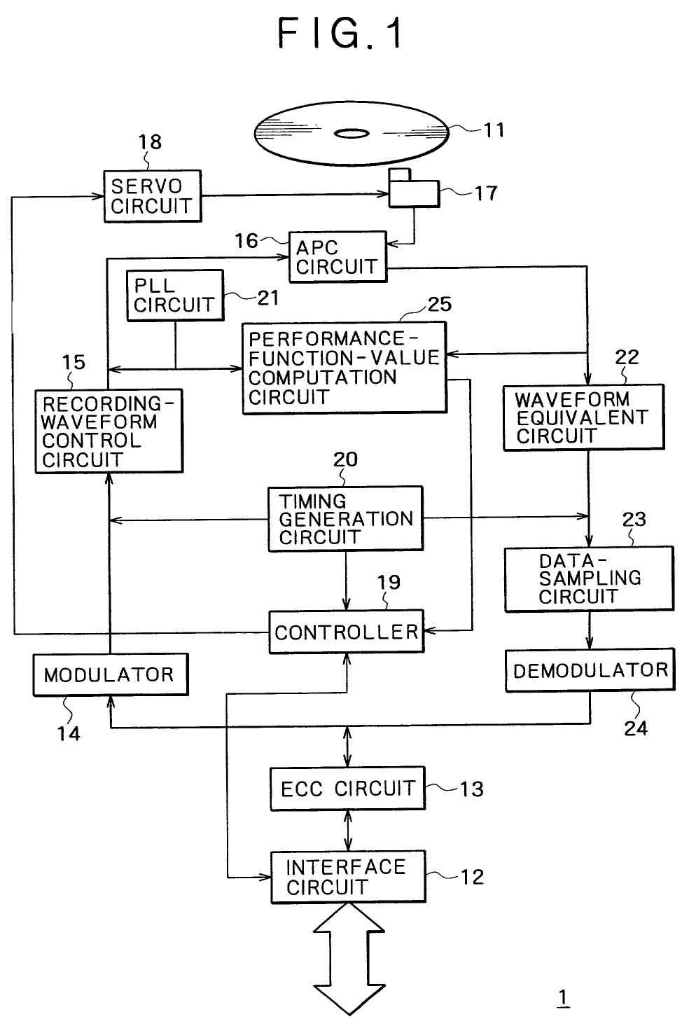

A preferred embodiment of the present invention is described by referring to the diagrams as follows. FIG. 1 is a diagram showing the configuration of a disk drive 1 provided by the present invention. The disk drive 1 is employed in a recording and playback apparatus for recording digital data received by typically an antenna not shown in the figure onto an optical disk 11 and playing back digital data from the optical disk 11 to be supplied to a television receiver which is also not shown in the figure either.

Connected to typically to a host computer of the recording and playback apparatus, an interface circuit 12 is used for exchanging data with the host computer and receiving commands from the computer which is not shown in the figure. Picture data or the like supplied to the interface circuit 12 is passed on to an ECC (Error Correcting Code) circuit 13. The circuit adds codes for correction of data to the supplied data before outputting the supplied data and the added codes to a modulator 14. The modulator 14 modulates the data by adoption of a modulation technique conforming to a recording technique embraced by the recording and playback apparatus and supplies the modulated signal to a recorded-waveform control circuit 15.

The recorded-waveform control circuit 15 converts the input data into data to be actually recorded onto the optical disk 11. That is to say, the data modulated by the modulator 14 is binary-converted data and, if control is executed to actually turn on and off a laser beam in accordance with the binary-converted data, pits are not created in a fine form. In order to solve this problem, the data generated by the modulator 14 is converted into data for turning the laser beam on and off and controlling the intensity of the laser beam in such a way that the data is recorded onto the optical disk 11 as pits created in a fine form.

Data output by the recorded-waveform control circuit 15 is supplied to an APC (Automatic Phase Control) circuit 16. The APC circuit 16 controls the intensity of the laser beam output by an optical pickup 17 on the basis of the data supplied by the recorded-waveform control circuit 15. In this way, the data is recorded onto the optical disk 11 as pits created in a fine form. It should be noted that the optical pickup 17 comprises components such as an optical system including a semiconductor laser for generating a laser beam, a playback amplifier and a 2-shaft actuator.

A servo circuit 18 executes tracking control and focus control of the optical pickup 17 in accordance with commands issued by a controller 19. The data described above is recorded onto the optical disk 11 at a timing determined by a timing generation circuit 20 in accordance with a clock signal generated by a PLL (Phase Locked Loop) circuit 21.

Data recorded on the optical disk 11 is read out by the optical pickup 17 and supplied to a waveform equivalent circuit 22 by way of the APC circuit 16. An RF signal representing the data supplied to the waveform equivalent circuit 22 is subjected to predetermined processing before being output to a data-fetching circuit 23. As a result of pieces processing carried out by the waveform equivalent circuit 22 and the data-fetching circuit 23, data of a form identical with the data output by the modulator 14 can be obtained. As described above, the data output by the modulator 14 is binary-converted data.

In a demodulator 24, data output by the data-fetching circuit 23 is subjected to demodulation inverse to the modulation carried out by the modulator 14. A result of the demodulation is supplied to the ECC circuit 13. The ECC circuit 13 corrects errors of the result of the demodulation and supplies the corrected-error data to an apparatus such as the host computer not shown in the figure by way of the interface circuit 12.

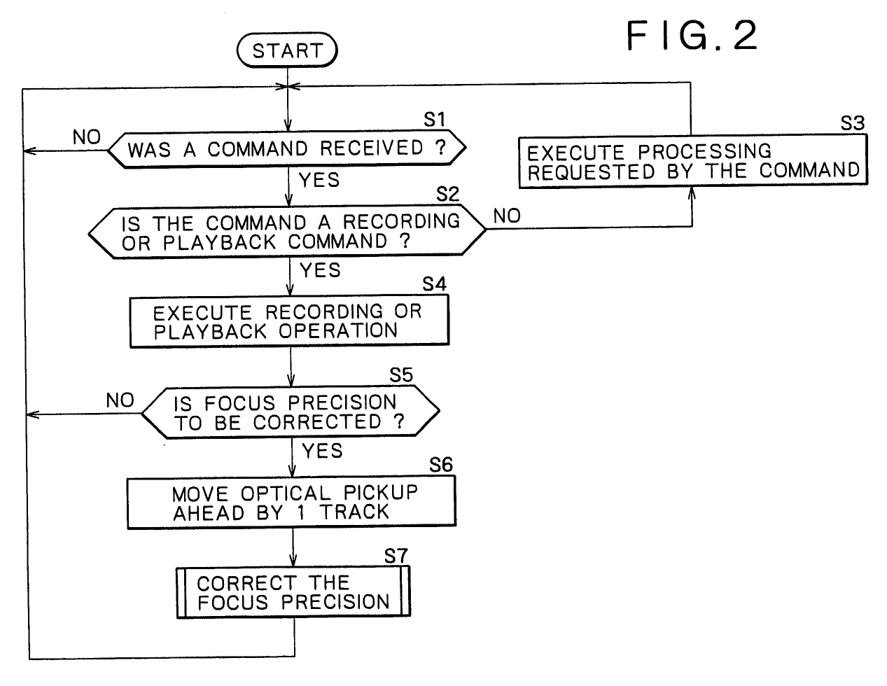

A performance-function-value computation circuit 25 is a circuit mainly used in correction of focus precision. Operations carried out by the disk drive 1 to correct the focus precision are explained by referring to a flowchart shown in FIG. 2. In the operations described below, the optical disk 11 is assumed to have already been mounted on the disk drive 1.

As shown in the figure, the flowchart begins with a step S1 at which the controller 19 forms a judgment as to whether or not a command has been received from the host computer by way of the interface circuit 12. The controller 19 forms this judgment of the step S1 repeatedly till a command is received from the host computer. That is to say, the controller 19 is put in a state of waiting for a command to be issued by the host computer. As the outcome of the judgment indicates that a command has been received from the host computer, the flow of the operations goes on to a step S2 to form a judgment as to whether the command is a command to record data onto the optical disk 11 or play back data from the optical disk 11.

If the outcome of the judgment formed at the step S2 indicates that the command is neither a command to record data onto the optical disk 11 nor a command to play back data from the optical disk 11, the flow of the operations goes on to a step S3 at which processing requested by the received command is carried out. In the case of an input command to temporarily stop the operations, for example, the controller 19 controls the servo circuit 18 not to change the position of the optical pickup 17.

If the outcome of the judgment formed at the step S2 indicates that the command is a command to record data onto the optical disk 11 or a command to play back data from the optical disk 11, on the other hand, the flow of the operations goes on to a step S4 at which a recording or playback operation requested by the received command is carried out. That is to say, if the command makes a request for a recording operation, for example, the pieces of processing described above are carried out by a variety of components to record the data received through the interface circuit 12 onto the optical disk 11. If the command makes a request for a playback operation, on the other hand, the pieces of processing described above are carried out by a variety of components to supply data read out by the optical pickup 17 from the optical disk 11 to an apparatus such as a television receiver not shown in the figure as playback data.

Then, the flow of the operations goes on to a step S5 to form a judgment as to whether or not to correct focus precision. If the outcome of the judgment formed at the step S5 indicates that the focus precision is not to be corrected, the flow of the operations goes back to the step S1 to carry out the pieces of processing of the step S1 and the subsequent steps. If the outcome of the judgment formed at the step S5 indicates that the focus precision is to be corrected, on the other hand, the flow of the operations goes on to a step S6.

By the way, once the user issues a recording or playback instruction to the recording and playback apparatus incorporating the disk drive 1, the user no longer needs to issue another instruction except an instruction to halt a recording or playback operation requested by the recording or playback instruction. On the other hand, the recording and playback apparatus needs to issue a recording or playback command for each predetermined data unit to the disk drive 1. In other words, during a period between a recording or playback instruction issued by the user and another instruction issued by the user to halt a recording or playback operation requested by the recording or playback instruction, the host computer employed by the recording and playback apparatus needs to issue recording or playback commands to the controller 19 employed in the disk drive 1.

If the step S5 to form a judgment is eliminated, focus precision will be inevitably corrected for each recording or playback command. Since the focus precision is not stabilized because of correction for each recording or playback command, however, the focus correction is corrected only if necessary.

A conceivable cause of a focus discrepancy is an increase in temperature inside the disk drive 1 with the lapse of time in a recording or playback operation. For this reason, the judgment as to whether or not to correct focus precision can be formed at the step S5 by determination of whether a period of time determined in advance has lapsed. The period of time determined in advance is a period of time during which it is quite within the bounds of possibility that a focus discrepancy occurs. If such a technique of determination is adopted, correction of the focus precision is deemed necessary when the predetermined period of time is determined to have lapsed.

As another method of forming a judgment at the step S5, a temperature detected by a sensor provided inside the disk drive 1 is examined to determine whether or not the temperature has increased by a predetermined raise. If such a method of judgment is adopted, correction of the focus precision is deemed necessary when the temperature detected by a sensor provided inside the disk drive 1 is determined to have increased by a predetermined raise.

It is needless to say that any other methods can be adopted to form a judgment as to whether or not to correct focus precision. If the outcome of the judgment formed at the step S5 indicates that the focus precision needs to be corrected in accordance with any of the methods described above, the flow of the operations goes on to a step S6 at which the controller 19 issues a command to the servo circuit 18 to move the optical pickup 17 from the current position to a position preceding the current one by 1 track.

In a state of the processing carried out at the step S6, a recording or playback operation has been executed. To be more specific, if a recording operation has been executed, at least data recorded at the step S4 now exists on the optical disk 11. If a playback operation has been executed, on the other hand, already recorded data must exist on the optical disk 11.

In either case, that is, in a case wherein a recording operation has been executed or a playback operation has been executed, recorded data must exist on a track preceding the current location of the optical pickup 17 on the optical disk 11 by 1 track. In addition, by playing back the existing data, an RF signal can be obtained. In this embodiment, focus precision is corrected by using an RF signal representing data recorded on a track preceding the current location of the optical pickup 17 on the optical disk 11 by 1 track.

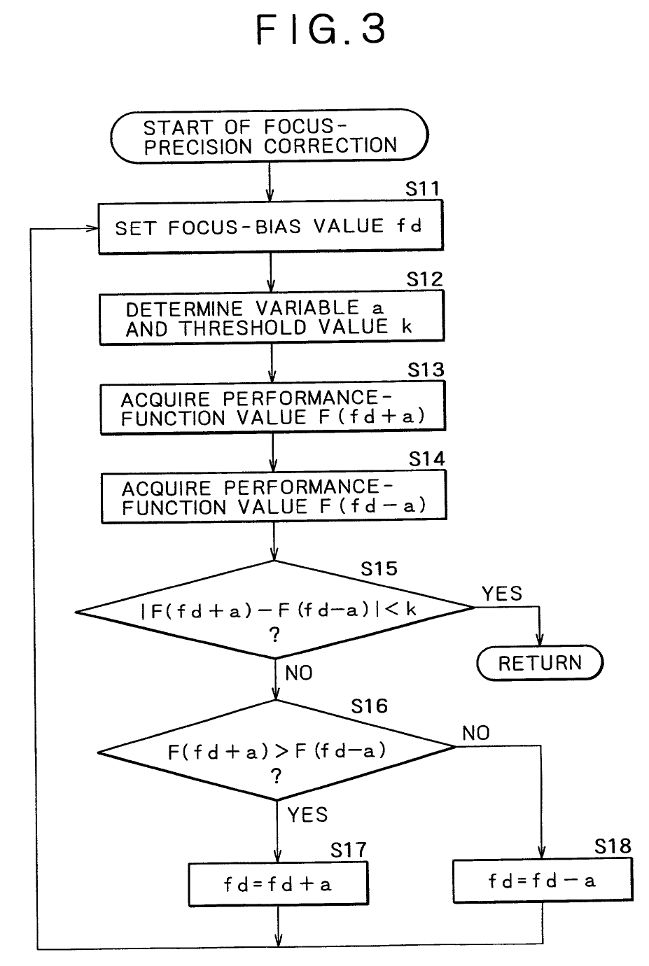

After the optical pickup 17 is moved at the step S6 to a track preceding the current location of the optical pickup 17 on the optical disk 11 by 1 track, the flow of the operations moves to a step S7 at which the focus precision is corrected. FIG. 3 is a flowchart representing details of the focus precision's correction carried out at the step S7.

As shown in the figure, the flowchart begins with a step S11 at which a focus-bias value fd is set. The focus-bias value fd set at the step S11 is stored in the controller 19 in advance. Normally, the focus-bias value fd set at the step S11 is stored in the controller 19 at the time the disk drive 1 is manufactured or stored as a value determined as a result of the focus precision's previous correction described as follows.

Then, at the next step S12, a change quantity a and a threshold value k are determined. Subsequently, at the next step S13, a performance-function value F(fd+a) is found. Then, at the next step S14, a performance-function value F(fd−a) is found.

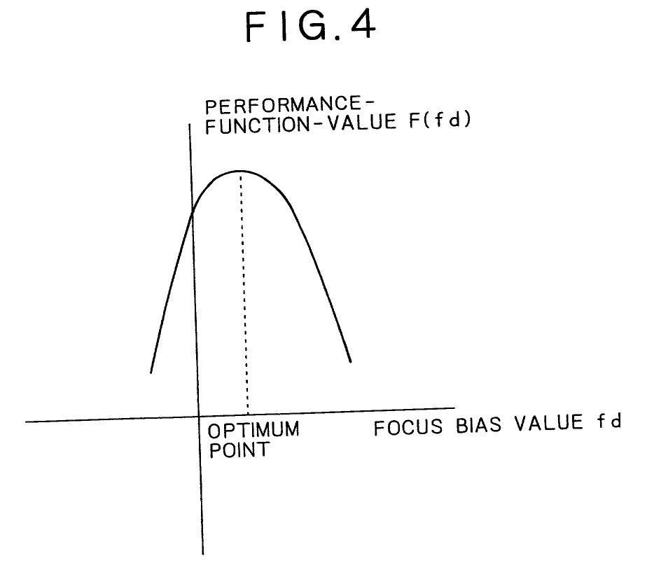

The performance-function value F(fd) is explained as follows. FIG. 4 is a curve showing a relation between the focus-bias value fd represented by the horizontal axis and the performance-function value F(fd) represented by the vertical axis.

The performance-function value F(fd) is computed by the performance-function-value computation circuit 25 on the basis of the amplitude or the value of jitters of an RF signal supplied to the performance-function-value computation circuit 25 by way of the APC circuit 16. The RF signal represents data read out by the optical pickup 17 from the position of the controlled focus on the optical disk 11. The focus is controlled by the servo circuit 18 on the basis of the focus-bias value fd set by the controller 19. The focus-bias value fd set by the controller 19 is changed continuously. For each value of the focus fd, the performance-function value F(fd) is computed to result in a relation between the focus-bias value fd and the focus fd, that is, a relation represented by the curve shown in FIG. 4.

The performance-function-value computation circuit 25 computes a performance-function value F(fd) based on the jitters value or the amplitude which is suitable for the configuration of the disk drive 1. To put it concretely, the computation of a performance-function value F(fd) is based on the jitters value or the amplitude which provides a more abrupt slope at the peak of a curve like the one shown in FIG. 4. Either the jitters value or the amplitude which that provides a more abrupt slope at the peak of the curve is more suitable for processing to correct focus precision as will be described later.

The curve like the one shown in FIG. 4 have shapes or values which vary in dependence on the optical disk 11 and have shapes varying in dependence on conditions including the temperature. That is to say, the curve does not have a univocal shape. In other words, the performance function cannot be expressed by one equation. Nevertheless, the shape has one peak all but like the one shown in FIG. 4, providing a curve symmetrical with respect to a vertical line passing through the peak point. The following description explains the curve representing a relation between the performance-function value F(fd) and the focus-bias value fd.

It is an object of the correction of the focus precision to determine a focus-bias value fd that coincides with a focus-bias value fd at an optimum point of the curve shown in FIG. 4, that is, a focus-bias value fd that provides the maximum of the performance-evaluation value F(fd).

Refer back to the flowchart shown in FIG. 3. As explained earlier, at the step S13, a performance-function value F(fd+a) is found as follows. First of all, the controller 19 adds the change quantity a found at the step S12 to the focus-bias value fd read out at the step S11, and gives a command to the servo circuit 18 to carry out focusing based on the focus-bias value (fd+a).

In accordance with this command, the servo circuit 18 carries out focusing based on the focus-bias value (fd+a). Then, at this focal position, an RF signal representing data read out by the optical pickup 17 from the optical disk 11 is supplied to the performance-function-value computation circuit 25 by way of the APC circuit 16. The performance-function-value computation circuit 25 computes a performance-function value F(fd+a) based on the jitters value or the amplitude which is extracted from the RF signal. The controller 19 acquires the performance-function value F(fd+a) obtained as a result of computation in such processing.

By carrying out the same processing, at the step S14, the controller 19 acquires the performance-function value F(fd−a).

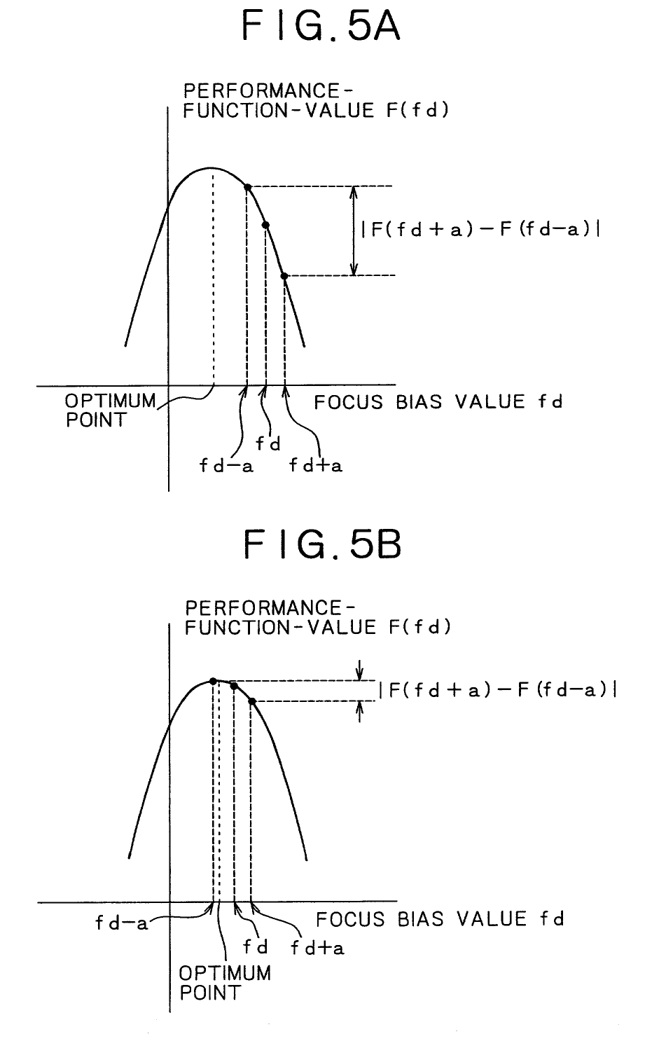

The flow of the operations then goes on to a step S15 to form a judgment as to whether or not the absolute value of (F(fd+a)−F(fd−a)) is smaller than the threshold value k. For a focus-bias value fd separated from the optimum point as shown in FIG. 5A, the absolute value of (F(fd+a)−F(fd−a)) is relatively large. For a focus-bias value fd close to the optimum point as shown in FIG. 5B, on the other hand, the absolute value of (F(fd+a)−F(fd−a)) is relatively small. From these relations, if the absolute value of (F(fd+a)−F(fd−a)) is smaller than the threshold value k, the focus-bias value fd can be judged to coincide with the optimum point or to be close enough to the optimum point within a tolerance range.

If the change quantity a and the threshold value k are each set at a small value, finer focus precision can be obtained or a higher degree of precision can be accomplished. With the change quantity a and the threshold value k each set at a small value, however, it takes more time to correct the focus precision. In order to solve this problem, at the step S12, the change quantity a and the threshold value k are determined. If the focus precision is corrected right after the optical disk 11 is mounted on the disk drive 1, for example, there is sufficient time for the correction of the focus precision. In this case, the change quantity a and the threshold value k are each set at a small value. If the focus precision is corrected while a recording or playback operation is being carried out, on the other hand, the change quantity a and the threshold value k are each set at a large value. This is because the focus was corrected to a high degree of precision right after the optical disk 11 was mounted on the disk drive 1 and there is no sufficient time for the correction of the focus precision during the recording and playback operation.

It is needles to say that the change quantity a and the threshold value k can also each be a value fixed from the beginning so that the processing of the step S12 can be omitted. In addition, if the focus precision is corrected right after the optical disk 11 is mounted on the disk drive 1, information recorded in a ROM area provided on the optical disk 11 can also be used for the correction. Thus, right after the optical disk 11 is mounted on the disk drive 1, the focus precision is corrected by using information recorded in the ROM area provided on the optical disk 11 or information recorded at a location outside the ROM area. The information recorded at a location outside the ROM area is data which has been recorded at the location and can be played back to generate an RF signal.

Refer back to the flowchart shown in FIG. 3. If the outcome of the judgment formed at the step S15 indicates that the absolute value of (F(fd+a)−F(fd−a)) is greater than the threshold value k, the flow of the operations goes on to a step S16 to form a judgment as to whether or not F(fd+a)>F(fd−a). If the outcome of the judgment indicates that F(fd+a)>F(fd−a), the flow of the operations goes on to a step S17. If the outcome of the judgment indicates that F(fd+a)≦F(fd−a), on the other hand, the flow of the operations goes on to a step S18.

An outcome of the judgment indicating that F(fd+a)≦F(fd−a) represents a state like the one shown in FIG. 5A. In such a state, the focus-bias value fd set at the step S11 is greater than the value at the optimum point. Thus, if the outcome of the judgment formed at the step S16 indicates that F(fd+a)≦F(fd−a), the flow of the operations goes on to the step S18 at which the focus-bias value fd is updated with (fd−a). The flow of the operations then goes back to the step S11 to repeat the pieces of processing of the step and the subsequent steps with the new focus-bias value fd.

If the outcome of the judgment formed at the step S16 indicates that F(fd+a)>F(fd−a), on the other hand, the flow of the operations goes on to the step S17 at which the focus-bias value fd is updated with (fd+a) for the same reason as the step S18. The flow of the operations then goes back to the step S11 to repeat the pieces of processing of the step and the subsequent steps with the new focus-bias value fd.

While the pieces of processing of the steps S11 to S18 are being carried out repeatedly as described above, the focus-bias value fd approaches the value at the optimum point. Then, as the outcome of the judgment formed at the step S15 indicates that the absolute value of (F(fd+a)−F(fd−a)) is smaller than the threshold value k or, in other words, as the focus-bias value fd is judged to coincide with the optimum point or to be close enough to the optimum point within a tolerance range, the current focus-bias value fd is used as a focus-bias value fd for executing focus control.

When the processing represented by the flowchart shown in FIG. 3 is ended, the flow of the operations goes back to the step S1 following the step S7 of the flowchart shown in FIG. 2 to repeat the pieces of processing of the step S1 and the subsequent steps. The processing represented by the flowchart shown in FIG. 2 is ended as an interrupt handling routine in an event such as an operation to turn off a power supply of the recording and playback apparatus.

As described above, while a recording or playback operation is being carried out, the focus precision is corrected by using an RF signal played back to represent data already recorded on a track closest to the current position of the optical pickup 17. Thus, the focus precision can be corrected in a short period of time and with a high degree of accuracy. As a result, processing to record or play back data in a real-time manner can be prevented from being disturbed by the correction of the focus precision.

The sequence of processes described above can be carried out by hardware or through execution of software. If the sequence of processes described above is carried out through execution of software, programs composing the software are carried out by a processor incorporated in dedicated hardware or by typically a general-purpose personal computer capable of performing a variety of functions. Such a personal computer has a variety of programs installed in recording media employed in the personal computer to be executed to perform the functions.

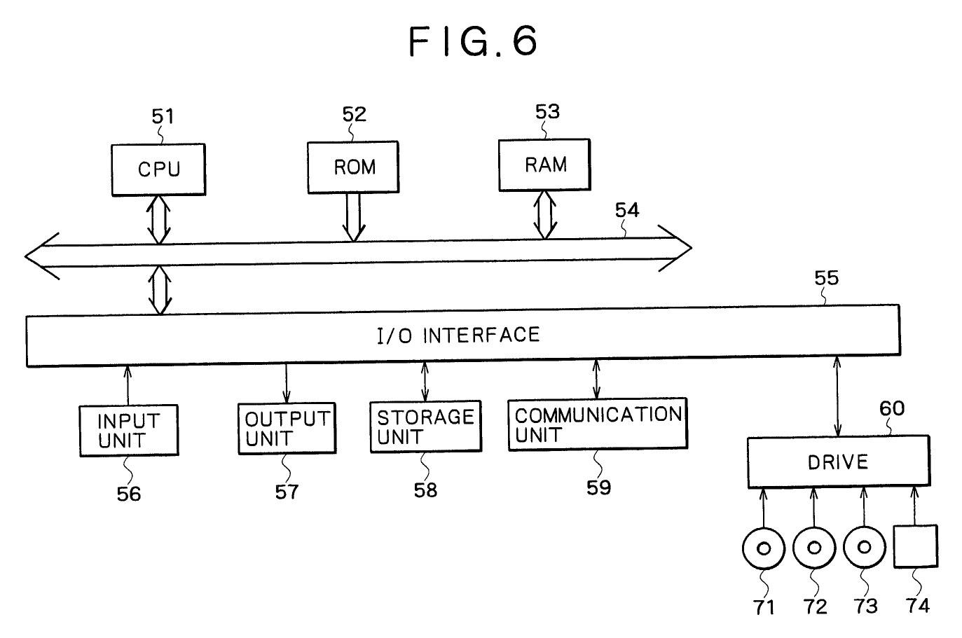

As shown in FIG. 6, the recording media is distributed separately from the computer to present the programs to the user. In order to present a program to the user, however, the use of package media is not mandatory. Examples of the package media are the magnetic disk 71 including a floppy disc, the optical disk 72 including a CD-ROM (Compact Disc Read-Only Memory) and a DVD (Digital Versatile Disk), the magnetic-optical disk 73 including an MD (Mini-Disk) and the semiconductor memory 74. As an alternative, a program can also be presented to the user by incorporating the program in the computer in advance. That is to say, the program is stored in the ROM 52 or a hard disk included in the storage unit 58.

It should be noted that, in this specification, while steps prescribed in a program recorded in a recording medium can of course be executed sequentially along the time axis in an order the steps are prescribed in the program, the steps are not always executed sequentially along the time axis. That is to say, a program may include steps that are executed concurrently or independently.

In addition, the technical term ‘system’ used in this specification means the whole equipment comprising a plurality of apparatuses.

While the preferred embodiment of the present invention has been described using the specific terms, such description is for illustrative purposes only, and it is to be understood that changes and variations may be made without departing from the spirit or scope of the following claims.

What is claimed is:

1. A recording and playback apparatus for recording data onto a predetermined recording medium and playing back said data from said recording medium, said recording and playback apparatus comprising:
judgment means for forming a judgment as to whether or not to correct focus precision in an operation to record data onto an Nth track of said recording medium or play back data from said Nth track; and
correction means which is used for correcting said focus precision if said judgment means forms a judgment to correct said focus precision in said operation to record data onto said Nth track of said recording medium or play back data from said Nth track by using a signal representing data existing on an already recorded track closest to said Nth track.

2. A recording and playback apparatus according to claim 1 wherein said judgment means is capable of forming a judgment to correct said focus precision if a predetermined period of time is determined to have lapsed.

3. A recording and playback apparatus according to claim 1 wherein said judgment means is capable of forming a judgment to correct said focus precision if a temperature inside a disk drive setting said recording medium is determined to have increased by a predetermined temperature raise.

4. A recording and playback apparatus according to claim 1 wherein said correction means is capable of correcting said focus precision by using a signal played back from an (N−1)th track immediately preceding said Nth track.

5. A recording and playback apparatus according to claim 1 wherein said correction means is capable of correcting said focus precision by determining a focus-bias value fd that provides the absolute value of a difference within a threshold value k where said difference is a difference in amplitude or a difference in jitters value between a signal obtained at a focus bias of (fd+a) and a signal obtained at a focus bias of (fd−a), and notation a denotes a change quantity.

6. A recording and playback method for recording data onto a predetermined recording medium and playing back said data from said recording medium, said recording and playback method comprising:
a judgment step of forming a judgment as to whether or not to correct focus precision in an operation to record data onto an Nth track of said recording medium or play back data from said Nth track; and
a correction step which is executed for correcting said focus precision if, at said judgment step, a judgment is formed to correct said focus precision in said operation to record data onto said Nth track of said recording medium or play back data from said Nth track by using a signal representing data existing on an already recorded track closest to said Nth track.

7. A recording medium for recording a program to be executed by a computer to record data onto a predetermined recording medium and play back said data from said recording medium, said program comprising:
a judgment step of forming a judgment as to whether or not to correct focus precision in an operation to record data onto an Nth track of said recording medium or play back data from said Nth track; and
a correction step which is executed for correcting said focus precision if, at said judgment step, a judgment is formed to correct said focus precision in said operation to record data onto said Nth track of said recording medium or play back data from said Nth track by using a signal representing data existing on an already recorded track closest to said Nth track.
